(19) United States
(12) Patent Application Publication
(10) Pub. No.: US 2012/0301190 A1
(43) Pub. Date: Nov. 29, 2012

(54) ELECTROCONDUCTIVE ENDLESS BELT

(75) Inventor: Ryuta Tanaka, Yokohama-shi (JP)

(73) Assignee: BRIDGESTONE CORPORATION, Chuo-ku, Tokyo (JP)

(21) Appl. No.: 13/576,788

(22) PCT Filed: Feb. 3, 2011
(86) PCT No.: PCT/JP2011/052219

§ 371 Date: Aug. 2, 2012

(30) Foreign Application Priority Data
Feb. 4, 2010 (JP) 2010-022817

(51) Int. Cl. G03G 15/14

(52) U.S. Cl. 399/297

(57) ABSTRACT

Provided is an electroconductive endless belt by which a good image with uniformity and without local unevenness can be obtained at a lower cost.

Provided is an electroconductive endless belt 100, which is used for an image forming apparatus, in the shape of an endless belt having a laminated structure provided with at least a base layer 101 and a cured resin layer 102 in the mentioned order from the inside. The base layer 101 contains a thermoplastic resin, the cured resin layer 102 contains an ultraviolet curable resin; an ionic conductive agent; at least one of 1,4-butanediol acrylate and a polytetramethylene glycol acrylate; and a polymer having an ethylene oxide, and the content of the ionic conductive agent is 0.5 to 5 parts by mass with respect to the total content 100 parts by mass of an ultraviolet curable resin; at least one of 1,4-butanediol acrylate and polytetramethylene glycol acrylate; and a polymer having an ethylene oxide.

### TECHNICAL FIELD

The present invention relates to an electroconductive endless belt (hereinafter, also simply referred to as “belt”) used to transfer a toner image onto a recording medium, such as paper, in an electrostatic recording process performed in an electrophotographic apparatus or an electrostatic recording apparatus, such as a copy machine or printer, which toner image is formed by providing a developer onto the surface of an image-forming member such as a latent image-retaining member retaining an electrostatic latent image on its surface.

### BACKGROUND ART

In an electrostatic recording process performed by a copy machine, printer or the like, conventionally, printing is carried out by a method comprising the steps of: first, uniformly charging the surface of a photoconductor (latent image-retaining member); projecting from an optical system an image onto this photoconductor; removing the charge from the part exposed to light to form an electrostatic latent image; subsequently providing a toner to the thus formed electrostatic latent image to form a toner image by electrostatic adsorption of the toner; and transferring the thus formed toner image onto a recording medium such as paper, OHP or photographic paper.

Also in a color printer and color copy machine, printing is performed basically in accordance with the aforementioned process; however, in the case of color printing, since color tones are reproduced by using four toners of magenta, yellow, cyan and black, it is necessary to carry out a step of overlaying these toners at a prescribed ratio to obtain desired color tones. Several techniques have been proposed for performing this step.

The first example of such technique is image-on-image development method. In this method, for visualization of an electrostatic latent image formed on a photoconductor by providing toners, an image is, in the same manner as in black-and-white printing, developed by sequentially overlaying the aforementioned four toners of magenta, yellow, cyan and black, thereby forming a color toner image on the photoconductor. This method enables a relatively compact apparatus configuration; however, it has a problem in that a high quality image cannot be obtained since gradation control is extremely difficult.

The second example of the aforementioned proposed technique is tandem method. In this method, a color image is reproduced by the steps of: developing latent images on each of four photoconductor drums using magenta toner, yellow toner, cyan toner or black toner to form toner each image by magenta, yellow, cyan or black; and sequentially transferring the toner images thus formed on the photoconductor drums, which are configured in a line, onto a recording medium such as paper to overlay the images on a recording medium. This method provides a good quality image; however, the apparatus is large and expensive since the four photoconductor drums, each of which has a charging mechanism and a developing mechanism, have to be configured in a line.

Illustrated in FIG. 2 is the constitution of a printing unit of an image-forming apparatus used in such tandem method. The printing unit has four printing units aligned sequentially corresponding to each toner of yellow (Y), magenta (M), cyan (C) and black (B), each printing unit of which is constituted by a photoconductor drum 1, a charging roller 2, a developing roller 3, a developing blade 4, a toner feeding roller 5 and a cleaning blade 6. The toners are sequentially transferred onto a sheet as it is carried by a conveyer belt 10, which is circularly driven by driving roller (driving member) 9s, thereby forming a color image. Charging of the conveyer belt and charge-removal therefrom are carried out by a charging roller 7 and a charge-removing roller 8, respectively. In addition, an adsorption roller (not shown) is used to charge the sheet in order to allow the sheet to adsorb onto the belt. By having such the above constitution, generation of ozone can be suppressed. The adsorption roller not only transfers the sheet from a sheet feeding path to the conveyer belt, but also performs electrostatic adsorption of the sheet onto the conveyer belt. Further, separation of the sheet therefrom after image transfer can be carried out solely by curvature separation.

The material of the conveyer belt 10 may be resistive or dielectric; however, each material type has its advantages and disadvantages. Since a resistive belt retains charges for only a short duration, in cases where such resistive belt is employed for the tandem-type transfer, there is only a limited amount of charge injection during the transfer and the increase in the voltage is relatively small even when four colors are consecutively transferred. Furthermore, even in cases where the resistive belt is repeatedly employed to consecutively transfer sheets, it is not required to electrically reset the belt since charges thereon should have been already released by the time of transferring the next sheet. However, such resistive belt has disadvantages in that the transfer efficiency is affected by environmental variations as the resistance value varies depending on the environmental variations, and that it is likely to be affected by the thickness and width of the printing sheet.

In contrast, a dielectric belt does not spontaneously release injected charges; therefore, injection and release of charges have to be controlled electronically. However, since the charges are stably retained by the belt, sheet adsorption is assured and sheet transfer is performed at a high accuracy. In addition, as the dielectric constant is less dependent on the temperature and humidity, the transfer process is relatively stable against environmental variations as well. A disadvantage of such dielectric belt is that charges are accumulated from repeated transfers, thereby increasing the transfer voltage.

The third example of the aforementioned proposed technique is transfer drum method in which a color image is reproduced by rotating a transfer drum, which is lapped with a recording medium such as paper, four times, in each of which rotation magenta, yellow, cyan or black toners on a photoconductor are sequentially transferred onto the recording medium. This method yields an image having a relatively high quality; however, in cases where the recording medium is a thick paper such as a postcard, since lapping of such recording medium around the transfer drum is difficult, this method has a problem in that the type of the recording medium is limited.

As an alternative method to the aforementioned image-on-image development method, tandem method and transfer drum method, intermediate transfer method, which yields a good quality image without particularly increasing the size of the apparatus and limiting the type of the recording medium, has been proposed.

That is, in this intermediate transfer method, an intermediate transfer member comprising a drum and a belt which transfer and temporarily retain a toner image formed on a photoconductor is provided, and around this intermediate transfer member, four photoconductors each having a toner image with magenta, a toner image with yellow, a toner image with cyan or toner image with black are arranged. The toner images of four colors are sequentially transferred onto the intermediate transfer member from the photoconductors, thereby forming a color image on this intermediate transfer member, which color image is then transferred onto a recording medium such as paper. Therefore, since the gradation is adjusted by overlaying the toner images of four colors, a high quality image can be obtained. At the same time, the apparatus does not have to be particularly scaled up since there is no need to lineally arrange the photoconductors as in the case of tandem method, and the type of recording medium is not restricted as the recording medium does not have to be lapped around the drum.

As an apparatus to perform color-image formation by such intermediate transfer method, FIG. 3 illustrates an image forming apparatus which comprises an intermediate transfer member in the form of an endless belt.

In FIG. 3, indicated as 11 is a drum photoconductor which rotates in the direction of the arrow. This photoconductor 11 is charged by a primary charging unit 12 and an image exposure unit 13 subsequently removes the charge from the part exposed to light, forming an electrostatic latent image corresponding to a first color component onto the photoconductor 11. By a developing unit 41, the thus formed electrostatic latent image is then developed with the first color, magenta toner (M), to form a toner image of the first color, magenta, onto the photoconductor 11. Subsequently, this toner image is transferred onto an intermediate transfer member 20, which is being circularly rotated in contact with the photoconductor 11 by a driving roller (driving member) 30. In this step, the image transfer from the photoconductor 11 onto the intermediate transfer member 20 is carried out at the nip portion between the photoconductor 11 and the intermediate transfer member 20 by primary transfer bias applied from a power source 61 to the intermediate transfer member 20. After the transfer of the toner image of the first color, magenta, onto this intermediate transfer member 20, the surface of the photoconductor 11 is cleaned by a cleaning unit 14, thereby completing the first round of the image development and transfer operation by the photoconductor 11. In each of the subsequent three rotations, by sequentially using developing units 42 to 44, a toner image of second color, cyan; a toner image of third color, yellow; and a toner image of fourth color, black, are sequentially formed onto the photoconductor 11 and superimposed onto the intermediate transfer member 20. Consequently, a composite color toner image corresponding to the desired color image is formed onto the intermediate transfer member 20. In the apparatus shown in FIG. 3, after each rotation of the photoconductor 11, the developing units 41 to 44 are sequentially placed into the position to perform sequential development by the magenta toner (M), cyano toner (C), yellow toner (Y), and black toner (B).

In the next step, the intermediate transfer member 20 onto which the aforementioned composite color toner image has been formed comes in contact with a transfer roller 25, and to the nip portion thereof, a recording medium 26 such as paper is fed from a paper feeding cassette 19. Simultaneously, secondary transfer bias is applied from a power source 29 to the transfer roller 25 and the composite color toner image is transferred and heat-fixed onto the recording medium 26 from the intermediate transfer member 20, thereby forming a final image. After the transfer of the composite color toner image onto the recording medium 26, residual toners on the surface of the intermediate transfer member 20 are removed by a cleaning unit 35 to return the intermediate transfer member 20 to the initial condition for the next image formation process.

There is also an intermediate transfer method combined with the tandem method. FIG. 4 illustrates an image forming apparatus of intermediate transfer method in which color images are formed using an intermediate transfer member in the form of an endless belt.

In the illustrated apparatus, a first developing unit 54a to a fourth developing unit 54d, which develop electrostatic latent images on photoconductor drums 52a to 52b with yellow, magenta, cyan and black, respectively, are sequentially arranged along an intermediate transfer member 50. This intermediate transfer member 50 is circularly driven in the direction of the arrow, and thereonto, toner images of four colors that have been formed on each of the photoconductor drums 52a to 52d of developing units 54a to 54d are sequentially transferred, thereby forming a color toner image onto this intermediate transfer member 50. The thus formed color toner image is then transferred onto a recording medium 53, such as paper, to be printed out. In any of the aforementioned apparatuses, the sequence of the toners used in the image development is not particularly restricted and can be arbitrarily selected.

In FIG. 4, the symbol 55 represents a driving roller or a tension roller for circularly driving the intermediate transfer member 50; the symbol 56a secondary transfer roller; the symbol 57a recording medium feeding device; a symbol 58a fixing device for fixing an image on a recording medium.

Conventionally, for the electroconductive endless belt used as the conveyer belt 10 in the form of an endless belt or an intermediate transfer member 20, 50 and the like, an electroconductive endless belt which uses a thermosetting resin as a base layer and has an ultraviolet curable resin layer as a surface layer on the base layer is known. In addition, for example, Patent Document 1 discloses a belt for electrophotography in which an ultraviolet curable resin containing a particulate metal oxide electroconductive agent such as an antimony doped tin oxide, a tin doped indium oxide or an aluminum doped zinc oxide is coated on a thermoplastic resin which is a base layer.

Further, Patent Document 2 discloses an intermediate transfer belt which is provided with a base layer containing a thermoplastic resin and a cured resin film having a thickness of 0.5 μm to 3 μm containing an electroconductive particle, the film being provided by coating on the base layer, and in which

the surface roughness of the cured film is defined. Still further, Patent Document 3 discloses an intermediate transfer body having a base layer whose glass transition temperature is 180° C. or lower and a surface layer whose main component is a resin curable by irradiating an activated light.

### RELATED ART DOCUMENTS

### Patent Documents

Patent Document 1: Japanese Unexamined Patent Application Publication No. 2006-330692 (claims and the like)
Patent Document 2: Japanese Unexamined Patent Application Publication No. 2007-183401 (claims and the like)
Patent Document 3: Japanese Unexamined Patent Application Publication No. 2008-46463 (claims and the like)

### SUMMARY OF THE INVENTION

### Problems to be Solved by the Invention

However, since the electroconductive metal particle has poor dispersibility in the cured resin layer and easy to aggregate, the methods according to Patent Documents 1 to 3 have a problem in that the resistance value varies widely and a uniform image cannot be obtained. In addition, since, generally, a significant amount, for example, 50 parts or more by mass of expensive electroconductive metal particle is required to be added, the methods also have a problem of high cost. Further, when a carbon black is added to an ultraviolet curable resin, an ultraviolet is not fully infiltrated into a cured resin layer, thereby causing incomplete curing.

An object of the present invention is to overcome the above-mentioned problems in the prior art, and to provide an electroconductive endless belt by which a good image with uniformity and without local unevenness can be obtained at a lower cost.

### Means for Solving the Problems

In order to solve the above-mentioned problems, the present inventor intensively studied to discover that the above-mentioned problems can be resolved by containing, in a cured resin layer, not an electroconductive metal particle but an ionic conductive agent, and by further containing a specific component, thereby completing the present invention.

That is, the electroconductive endless belt of the present invention is an electroconductive endless belt, which is used for an image forming apparatus, in the shape of an endless belt having a laminated structure provided with at least a base layer and a cured resin layer in the mentioned order from the inside, wherein

the base layer contains a thermoplastic resin,

the cured resin layer contains an ultraviolet curable resin; an ionic conductive agent; at least one of 1,4-butanediol acrylate and a polytetramethylene glycol acrylate; and a polymer having an ethylene oxide, and

the content of the ionic conductive agent is 0.5 to 5 parts by mass with respect to the total content 100 parts by mass of: an ultraviolet curable resin; at least one of 1,4-butanediol acrylate and polytetramethylene glycol acrylate; and a polymer having an ethylene oxide.

In the electroconductive endless belt of the present invention, the ionic conductive agent is preferably a tertiary ammonium salt, and the tertiary ammonium salt is preferably represented by the following general formula (I):

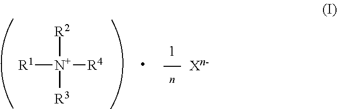

(wherein R¹ represents an alkyl group having 1 to 30 carbons, an aryl group having 6 to 30 carbons or an aralkyl group having 7 to 30 carbons; R², R³ and R⁴ each independently represent an alkyl group having 1 to 6 carbons; Xⁿ⁻ represents n-valent anion; and n is an integer of 1 to 6).

In the electroconductive endless belt of the present invention, the content of at least one of the 1,4-butanediol acrylate and polytetramethylene glycol acrylate is preferably 10 to 30 parts by mass with respect to 100 parts by mass of an ultraviolet curable resin; and the content of the polymer having an ethylene oxide is preferably 10 to 30 parts by mass with respect to 100 parts by mass of an ultraviolet curable resin.

### Effects of the Invention

According to the present invention, by having the above-mentioned constitution, an electroconductive endless belt by which a good image with uniformity and without local unevenness can be obtained at a lower cost can be attained.

### BRIEF DESCRIPTION OF THE DRAWINGS

FIG. 1 is a cross-sectional view showing an electroconductive endless belt according to one embodiment of the present invention in the width direction.

FIG. 2 is a schematic view showing an image forming apparatus of tandem method using a conveyer belt, as one example of the image forming apparatus.

FIG. 3 is a schematic view showing an intermediate transfer apparatus using an intermediate transfer member, as another example of the image forming apparatus.

FIG. 4 is a schematic view showing an intermediate transfer apparatus using an intermediate transfer member, as still another example of the image forming apparatus according to the present invention.

### MODE FOR CARRYING OUT THE INVENTION

Preferred embodiments of the present invention will now be described in detail.

Electroconductive endless belts are generally grouped into jointed belts and jointless belts (so-called seamless belts). The present invention can be either of them; however, it is preferably a seamless belt. As already described, the electroconductive endless belt according to the present invention can be used as a transfer member or the like in the tandem method and intermediate transfer method.

In cases where the electroconductive endless belt of the present invention is, for example, the conveyer belt represented by the reference symbol 10 in FIG. 2, the belt is driven by a driving member such as the driving roller 9 and toners are sequentially transferred onto a recording medium as the recording medium is carried by the belt, thereby forming a color image.

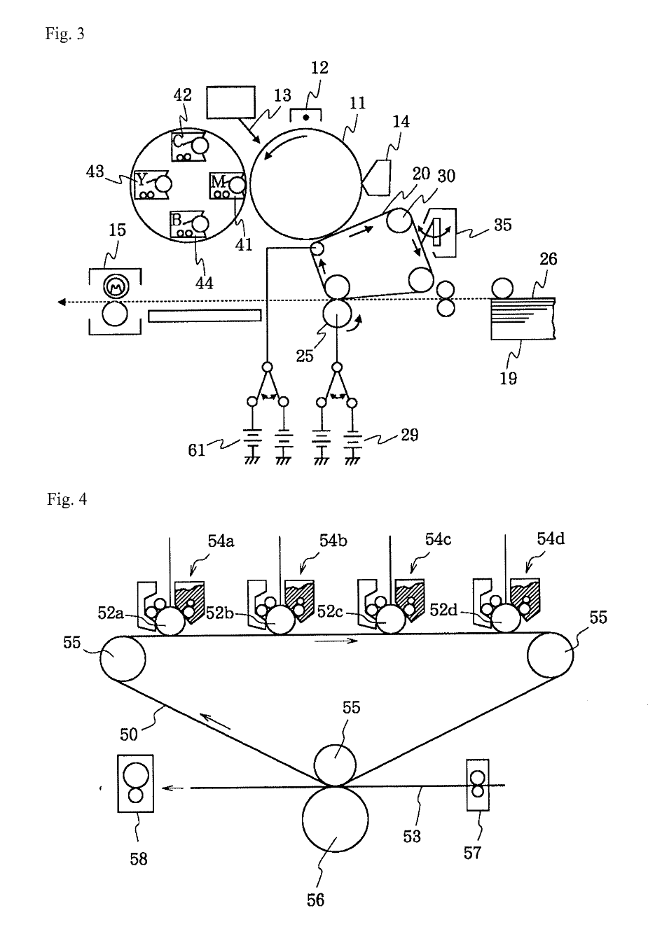

Further, in cases where the electroconductive endless belt of the present invention is, for example, the intermediate transfer member represented by the reference symbol 20 in FIG. 3, by arranging the intermediate transfer member, which is circularly driven by a driving member such as the driving roller 30, between the photoconductor drum (latent image-retaining member) 11 and the recording medium 26 such as paper, a toner image formed on the surface of the aforementioned photoconductor drum 11 is temporarily retained on the intermediate transfer member 20 and subsequently transferred onto the recording medium 26. As already described, the apparatus of FIG. 3 performs color printing by the intermediate transfer method.

Furthermore, in cases where the electroconductive endless belt of the present invention is, for example, the intermediate transfer member represented by the reference symbol 50 in FIG. 4, by arranging the intermediate transfer member, which is circularly driven by a driving member such as the driving member 55, between the developing units 54a to 54d equipped with the photoconductor drums 52a to 52d and the recording medium 53 such as paper, toner images of four colors formed onto the surface of each of the photoconductor drums 52a to 52d are temporarily retained and subsequently transferred onto the recording medium 53, thereby forming a color image. Explained in the above is concerning the cases where toners of four colors are used; however, it is needless to say that toners are not restricted to four colors in any of the aforementioned apparatuses.

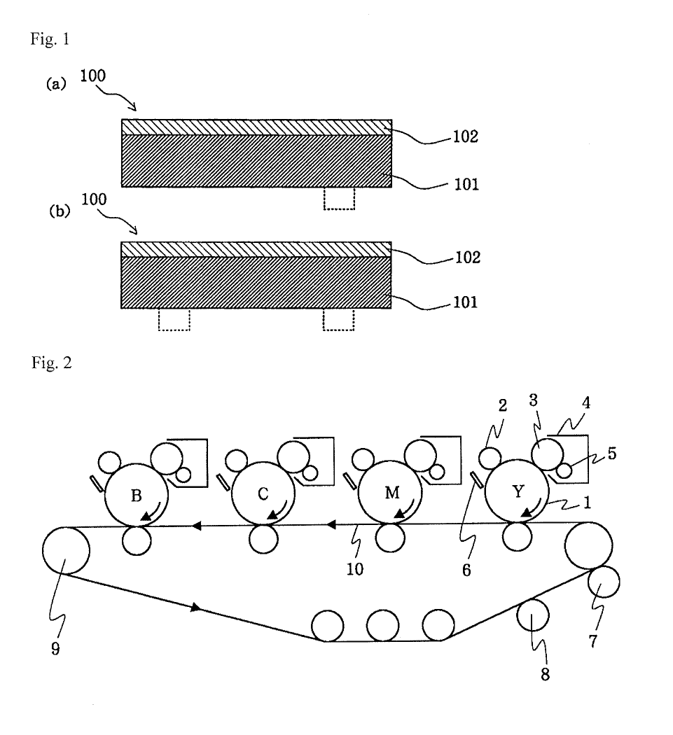

FIG. 1 illustrates a cross-sectional view of an electroconductive endless belt according to one preferred embodiment of the present invention in the width direction. As illustrated in FIG. 1, the electroconductive endless belt 100 of the present invention is in the shape of an endless belt and has a laminated structure provided with at least a base layer 101 and a cured resin layer (hereinafter, also referred to as “resin layer”) 102 in the mentioned order from the inside. In addition, the base layer 101 contains thermoplastic resin, and the cured resin layer 102 contains an ultraviolet curable resin; an ionic conductive agent; at least one of 1,4-butanediol acrylate and polytetramethylene glycol acrylate; and a polymer having an ethylene oxide. Further, the content of the ionic conductive agent is 0.5 to 5 parts by mass with respect to the total content 100 parts by mass of: an ultraviolet curable resin; at least one of 1,4-butanediol acrylate and polytetramethylene glycol acrylate; and a polymer having an ethylene oxide. By having such a constitution, the dispersibility of the ionic conductive agent becomes favorable, and the resistance value becomes stable to make the variation of the resistance value little, thereby obtaining an image with uniformity. Further, the flexibility of the surface layer can be obtained, and breakage of a belt can be prevented.

That is, in the present invention, it is essential that, in the cured resin layer 102, an ionic conductive agent; at least one of 1,4-butanediol acrylate and polytetramethylene glycol acrylate as a substance for retaining the agent; and a polymer having an ethylene oxide as a substance having a good water-absorbing quality for allowing ions to move easily be contained. The resin layer 102 according to the present invention is composed of one layer in the illustrated example, and may also be composed of a plurality of layers being different from each other in their material or physical properties. In the case of a plurality of layers, at least one layer among those is a layer containing the above-mentioned ultraviolet curable resin.

The ultraviolet curable resin employed in the present invention refers to a resin which is cured by irradiating ultraviolet (UV) having a wavelength of about 200 to 400 nm, and is usually composed of prepolymer, monomer, an ultraviolet polymerization initiator and additives. Specific examples thereof include polyester resin, polyether resin, fluorine resin, epoxy resin, amino resin, polyamide resin, acryl resin, acrylic urethane resin, urethane resin, alkyd resin, phenol resin, melamine resin, urea resin, silicone resin, polyvinyl butyral resin, and one of these or two or more of these which are mixed can be used.

Modified resins obtained by introducing a specific functional group into the resins may also be employed, and particularly those having a cross-linking structure are preferably introduced into the resins in order to improve the mechanical strength or environment-resistant characteristics of the resin layer 102.

Among the above-mentioned ultraviolet curable resins, those using a polyfunctional acrylate monomer having two or more (meth)acryloyl groups such as dipentaerythritol hexaacrylate, or (meth)acrylate ultraviolet curable resins including (meth)acrylate oligomer are particularly suitable.

Examples of such a (meth)acrylate oligomer include a urethane (meth)acrylate oligomer, an epoxy (meth)acrylate oligomer, an ether (meth)acrylate oligomer, an ester (meth)acrylate oligomer and a polycarbonate (meth)acrylate oligomer, and also include fluorine, silicone (meth)acryl oligomer.

The above-mentioned (meth)acrylate oligomer can be synthesized by a reaction between a compound such as polyethylene glycol, polyoxypropylene glycol, polytetramethylene ether glycol, bisphenol A epoxy resin, phenol novolac epoxy resin, addition product of polyhydric alcohol and ∈-caprolactone, and (meth)acrylic acid, or by urethanating a polyisocyanate compound and a (meth)acrylate compound having a hydroxyl group.

Urethane (meth)acrylate oligomer can be obtained by urethanating a polyol, isocyanate compound and a (meth)acrylate compound having a hydroxyl group.

Examples of the epoxy (meth)acrylate oligomer include any reaction products of a compound having a glycidyl group, and (meth)acrylic acid. Among the products, reaction products of a compound having a ring structure(s) such as benzene ring, naphthalene ring, spiro ring, dicyclopentadiene and/or tricyclodecane and having a glycidyl group, and (meth)acrylic acid are preferred.

Further, ether (meth)acrylate oligomer, ester (meth)acrylate oligomer and polycarbonate (meth)acrylate oligomer can be obtained by reactions of corresponding polyols (polyether polyol, polyester polyol and polycarbonate polyol) and (meth)acrylic acid, respectively.

The ultraviolet curable resin contains a reactive diluent having a polymerizable double bond for adjusting the viscosity as required. As such a reactive diluent, a monofunctional, difunctional or polyfunctional polymerizable compound or the like having a structure in which a (meth)acrylic acid is bonded by an esterification reaction and an amidation reaction to a compound containing an amino acid or a hydroxyl group may be used. Such diluents are preferably used usually in an amount of 10 to 200 parts by mass with respect to 100 parts by mass of (meth)acrylate oligomer.

The ultraviolet curable resin contains an ultraviolet polymerization initiator for facilitating the initiation of curing reaction by ultraviolet irradiation. Such an ultraviolet polymerization initiator is not particularly restricted and known initiators can be used. In particular, when irradiated ultraviolet does not reach inside the resin layer 102, and the function of the ultraviolet polymerization initiator is not sufficiently made use of, and the curing reaction may not proceed, an ultraviolet polymerization initiator having a sensitivity to a long wavelength ultraviolet which is easy to penetrate inside the resin layer 102 is preferably used.

Specifically, an ultraviolet polymerization initiator having a maximal wavelength in the ultraviolet absorption wavelength band of 400 nm or longer is suitably used. As an ultraviolet polymerization initiator having an absorption range in such a long wavelength, α-aminoacetophenone, acyl phosphine oxide, thio xanthon/amine or the like can be used, and specific examples thereof include bis(2,4,6-trimethylbenzoyl)-phenylphosphine oxide or 2-methyl-1-[4-(methylthio)phenyl]-2-morpholinopropane-1-one.

In this case, as the ultraviolet polymerization initiator, other than the above-mentioned initiators, an ultraviolet polymerization initiator having a maximal wavelength in the ultraviolet absorption wavelength band of shorter than 400 nm is preferably contained. By this, particularly in cases where a carbon-based conducting agent is used, curing reaction can be allowed to proceed favorably not only inside the resin layer 102, but also in the vicinity of the surface of the resin layer 102.

Examples of an ultraviolet polymerization initiator having an absorption range in such a short wavelength include 2,2-dimethoxy 1,2diphenylethane-1-one, 1-hydroxy-cyclohexyl-phenylketone, 2-hydroxy-2-methyl-1-phenylpropane-1-one, 1-[4-(2hydroxyethoxy)phenyl]2-hydroxy-2-methyl-1-propane-1-one and 2-methyl-1-[4-phenyl]-2-morpholinopropane-1-one.

The amount of such an ultraviolet polymerization initiator added is preferably, for example, 0.1 to 10 parts by mass with respect to 100 parts by mass of (meth)acrylate oligomer.

To the resin layer 102, other than the above-mentioned components, a tertiary amine such as triethylamine or triethanol amine; an alkylphosphine photopolymerization accelerator such as triphenylphosphine; a thioether photopolymerization accelerator such as p-thiodiglycol, or the like may be added to the ultraviolet curable resin in order to facilitate the polymerization reaction by the above-mentioned ultraviolet polymerization initiator. When these compounds are added, the amount thereof is preferably usually in a range of 0.01 to 10 parts by mass with respect to 100 parts by mass of (meth)acrylate oligomer.

At least as for the resin layer 102 positioned at the outermost side, the ultraviolet curable resin constituting the layer preferably contains either one or both of fluorine and silicon. By this, the surface energy of the resin layer 102 of the outermost layer can be reduced, and as a result, the frictional resistance of the belt surface can be reduced, as well as the toner release ability can also be improved, and the abrasion in a long term use is reduced to improve the durability.

The raw material of the fluorine-containing ultraviolet curable resin preferably contains a fluorine-containing compound having a polymerizable double bond between carbon atoms, or may be comprised of only a fluorine-containing compound having a polymerizable double bond between carbon atoms. The resin may also be composed of a composition obtained by blending a fluorine-containing compound having a polymerizable double bond between carbon atoms and another type of compound having a polymerizable double bond between carbon atoms.

As the fluorine-containing compound having a polymerizable double bond between carbon atoms, fluoroolefins and fluoro(meth)acrylates are suitable.

As the fluoroolefins, a C2-12 fluoroolefin in which 1 to all hydrogen atoms are substituted by fluorine is suitable, and specific examples thereof include hexafluoropropene [CF₃CF═CF₂, fluorine content 76% by mass], (perfluorobutyl)ethylene [F(CF₂)₄CH═CH₂, fluorine content 69% by mass], (perfluorohexyl)ethylene [F(CF₂)₆CH═CH₂, fluorine content 71% by mass], (perfluorooctyl)ethylene [F(CF₂)₈CH═CH₂, fluorine content 72% by mass], (perfluorodecyl)ethylene [F(CF₂)₁₀CH═CH₂, fluorine content 73% by mass], chlorotrifluoroethylene [CF₂═CFCl, fluorine content 49% by mass], 1-methoxy-(perfluoro-2-methyl-1-propene [(CF₃)₂C═CFOCH₃, fluorine content 63% by mass], 1,4-divinyloctafluorobutane [(CF₂)₄(CH═CH₂)₂, fluorine content 60% by mass], 1,6-divinyldodecafluorohexane [(CF₂)₆(CH═CH₂)₂, fluorine content 64% by mass] and 1,8-divinylhexadecafluorooctane [(CF₂)_{g}(CH═CH₂)₂, fluorine content 67% by mass].

As the fluoro(meth)acrylates, a C5-16 fluoroalkyl(meth)acrylate in which 1 to all hydrogen atoms are substituted by fluorine is suitable, and specific examples thereof include 2,2,2-trifluoro ethyl acrylate (CF₃CH₂OCOCH═CH₂, fluorine content 34% by mass), 2,2,3,3,3-pentafluoropropyl acrylate (CF₃CF₂CH₂OCOCH═CH₂, fluorine content 44% by mass), F(CF₂)₄CH₂CH₂OCOCH═CH₂(fluorine content 51% by mass), 2,2,2-trifluoro ethyl acrylate [CF₃CH₂OCOCH═CH₂, fluorine content 37% by mass], 2,2,3,3,3-pentafluoropropyl acrylate [CF₃CF₂CH₂OCOCH═CH₂, fluorine content 47% by mass], 2-(perfluorobutyl)ethyl acrylate [F(CF₂)₄CH₂CH₂OCOCH═CH₂, fluorine content 54% by mass], 3-(perfluorobutyl)-2-hydroxypropyl acrylate [F(CF₂)₄CH₂CH(OH)CH₂OCOCH═CH₂, fluorine content 49% by mass], 2-(perfluorohexyl)ethyl acrylate [F(CF₂)₆CH₂CH₂OCOCH═CH₂, fluorine content 59% by mass], 3-(perfluorohexyl)-2-hydroxypropyl acrylate [F(CF₂)₆CH₂CH(OH)CH₂OCOCH═CH₂, fluorine content 55% by mass], 2-(perfluorooctyl) ethyl acrylate [F(CF₂)₈CH₂CH₂OCOCH═CH₂, fluorine content 62% by mass], 3-(perfluorooctyl)-2-hydroxypropyl acrylate [F(CF₂)₈CH₂CH(OH)CH₂OCOCH═CH₂, fluorine content 59% by mass], 2-(perfluorodecyl)ethyl acrylate [F(CF₂)₁₀CH₂CH₂OCOCH═CH₂, fluorine content 65% by mass], 2-(perfluoro-3-methylbutyl)ethyl acrylate [(CF₃)₂CF(CF₂)₂CH₂CH₂OCOCH═CH₂, fluorine content 57% by mass], 3-(perfluoro-3-methylbutyl)-2-hydroxypropyl acrylate [(CF₃)₂CF(CF₂)₂CH₂CH(OH)CH₂OCOCH═CH₂, fluorine content 52% by mass], 2-(perfluoro-5-methylhexyl)ethyl acrylate [(CF₃)₂CF(CF₂)₄CH₂CH₂OCOCH═CH₂, fluorine content 61% by mass], 3-(perfluoro-5-methylhexyl)-2-hydroxypropyl acrylate [(CF₃)₂CF(CF₂)₄CH₂CH(OH)CH₂OCOCH═CH₂, fluorine content 57% by mass], 2-(perfluoro-7-methyloctyl)ethyl acrylate [(CF₃)₂CF(CF₂)₆CH₂CH₂OCOCH═CH₂, fluorine content 64% by mass], 3-(perfluoro-7-methyloctyl)-2-hydroxypropyl acrylate [(CF₃)₂CF(CF₂)₆CH₂CH(OH)CH₂OCOCH═CH₂, fluorine content 60% by mass], 1H,1H,3H-tetrafluoropropyl acrylate [H(CF₂)₂CH₂OCOCH═CH₂, fluorine content 41% by mass], 1H,1H,5H-octafluoropentyl acrylate [H(CF₂)₄CH₂OCOCH═CH₂, fluorine content 53% by mass], 1H,1H,7H-dodecafluoroheptyl acrylate [H(CF₂)₆CH₂OCOC(CH₃)═CH₂, fluorine content 59% by mass], 1H,1H,9H-hexadecafluorononyl acrylate [H(CF₂)₈CH₂OCOCH═CH₂, fluorine content 63% by mass], 1H-1-(trifluoromethyl)trifluoro ethyl acrylate [(CF₃)₂CHOCOCH═CH₂, fluorine content 51% by mass], 1H,1H,3H-hexafluorobutyl acrylate [CF₃CHFCF₂CH₂OCOCH═CH₂, fluorine content 48% by mass], 2,2,2-trifluoro ethyl methacrylate [CF₃CH₂OCOC(CH₃)═CH₂, fluorine content 34% by mass], 2,2,3,3,3-pentafluoropropyl methacrylate [CF₃CF₂CH₂OCOC(CH₃)═CH₂, fluorine content 44% by mass], 2-(perfluorobutyl)ethyl methacrylate [F(CF₂)₄CH₂CH₂OCOC(CH₃)═CH₂, fluorine content 51% by mass], 3-(perfluorobutyl)-2-hydroxypropyl methacrylate [F(CF₂)₄CH₂CH(OH)CH₂OCOC(CH₃)═CH₂, fluorine content 47% by mass], 2-(perfluorohexyl)ethyl methacrylate [F(CF₂)₆CH₂CH₂OCOC(CH₃)═CH₂, fluorine content 57% by mass], 3-(perfluorohexyl)-2-hydroxypropyl methacrylate [F(CF₂)₆CH₂CH(OH)CH₂OCOC(CH₃)═CH₂, fluorine content 53% by mass], 2-(perfluorooctyl)ethyl methacrylate [F(CF₂)₈CH₂CH₂OCOC(CH₃)═CH₂, fluorine content 61% by mass], 3-perfluorooctyl-2-hydroxypropyl methacrylate [F(CF₂)₈CH₂CH(OH)CH₂OCOC(CH₃)═CH₂, fluorine content 57% by mass], 2-(perfluorodecyl)ethyl methacrylate [F(CF₂)₁₀CH₂CH₂OCOC(CH₃)═CH₂, fluorine content 63% by mass], 2-(perfluoro-3-methylbutyl)ethyl methacrylate [(CF₃)₂CF(CF₂)₂CH₂CH₂OCOC(CH₃)═CH₂, fluorine content 55% by mass], 3-(perfluoro-3-methylbutyl)-2-hydroxypropyl methacrylate [(CF₃)₂CF(CF₂)₂CH₂CH(OH)CH₂OCOC(CH₃)═CH₂, fluorine content 51% by mass], 2-(perfluoro-5-methylhexyl)ethyl methacrylate [(CF₃)₂CF(CF₂)₄CH₂CH₂OCOC(CH₃)═CH₂, fluorine content 59% by mass], 3-(perfluoro-5-methylhexyl)-2-hydroxypropyl methacrylate [(CF₃)₂CF(CF₂)₄CH₂CH(OH)CH₂OCOC(CH₃)═CH₂, fluorine content 56% by mass], 2-(perfluoro-7-methyloctyl)ethyl methacrylate [(CF₃)₂CF(CF₂)₆CH₂CH₂OCOC(CH₃)═CH₂, fluorine content 62% by mass], 3-(perfluoro-7-methyloctyl)-2-hydroxypropyl methacrylate [(CF₃)₂CF(CF₂)₆CH₂CH(OH)CH₂OCOC(CH₃)═CH₂, fluorine content 59% by mass], 1H,1H,3H-tetrafluoropropyl methacrylate [H(CF₂)₂CH₂OCOC(CH₃)═CH₂, fluorine content 51% by mass], 1H,1H,5H-octafluoropentyl methacrylate [H(CF₂)₄CH₂OCOC(CH₃)═CH₂, fluorine content 51% by mass], 1H,1H,7H-dodecafluoroheptyl methacrylate [H(CF₂)₆CH₂OCOC(CH₃)═CH₂, fluorine content 57% by mass], 1H,1H,9H-hexadecafluorononyl methacrylate [H(CF₂)₈CH₂OCOC(CH₃)═CH₂, fluorine content 61% by mass], 1H-1-(trifluoromethyl)trifluoro ethyl methacrylate [(CF₃)₂CHOCOC(CH₃)═CH₂, fluorine content 48% by mass] and 1H,1H,3H-hexafluorobutyl methacrylate [CF₃CHFCF₂CH₂OCOC(CH₃)═CH₂, fluorine content 46% by mass].

The above-mentioned fluorine-containing compound having a polymerizable double bond between carbon atoms is preferably monomer, oligomer or a mixture of monomer and oligomer. The oligomer is preferably dimer to icosamer.

The other type of compound having a polymerizable double bond between carbon atoms which may be blended with the fluorine-containing compound having a polymerizable double bond between carbon atoms is not particularly restricted, and suitably (meth)acrylate monomer or oligomer, or a mixture of monomer and oligomer.

Examples of the (meth)acrylate monomer or oligomer include urethane (meth)acrylate, epoxy (meth)acrylate, ether (meth)acrylate, ester (meth)acrylate and polycarbonate (meth)acrylate monomer or oligomer, and a silicone (meth)acryl monomer or oligomer.

The above-mentioned (meth)acrylate oligomer can be synthesized by a reaction of a compound such as polyethylene glycol, polyoxypropylene glycol, polytetramethyleneetherglycol, bisphenol A type epoxy resin, phenol novolac epoxy resin or addition products of polyhydric alcohol and ∈-caprolactone, and (meth)acrylic acid, or by urethanating a polyisocyanate compound and a (meth)acrylate compound having a hydroxyl group.

Urethane (meth)acrylate oligomer can be obtained by urethanating a polyol, isocyanate compound and a (meth)acrylate compound having a hydroxyl group.

Examples of the epoxy (meth)acrylate oligomer include any reaction products of a compound having a glycidyl group, and (meth)acrylic acid. Among the products, reaction products of a compound having a ring structure(s) such as benzene ring, naphthalene ring, spiro ring, dicyclopentadiene and/or tricyclodecane and having a glycidyl group, and (meth)acrylic acid are preferred.

Further, ether (meth)acrylate oligomer, ester (meth)acrylate oligomer and polycarbonate (meth)acrylate oligomer can be obtained by reactions of corresponding polyols (polyether polyol, polyester polyol and polycarbonate polyol) and (meth)acrylic acid, respectively.

The raw material forming the silicon-containing ultraviolet curable resin preferably contains a silicon-containing compound having a polymerizable double bond between carbon atoms, or may be comprised of only a silicon-containing compound having a polymerizable double bond between carbon atoms. The resin may also be composed of a composition obtained by blending a silicon-containing compound having a polymerizable double bond between carbon atoms and another type of compound having a polymerizable double bond between carbon atoms.

As the silicon-containing compound having a polymerizable double bond between carbon atoms, dual-end type reactive silicon oils, single-end type reactive oils and (meth) acryloxyalkyl silanes are suitable. As the reactive silicone oils, those into the end of which a (meth)acryl group is introduced are preferred.

Specific examples of a silicon-containing compound suitably used in the present invention are illustrated below.

Illustrated is a dual-end type reactive silicone oil (having a functional group shown in Formula (I) below:

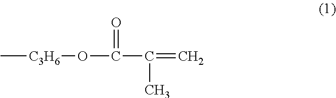

) manufactured by Shin-Etsu Chemical Co., Ltd. shown in Table 1 below.

TABLE 1

| | | Functional group |
|---|---|---|
| | Viscosity | equivalent |
| Product name | (mm²/s) | (g/mol) |
| X-22-164A | 25 | 860 |
| X-22-164B | 55 | 1630 |
| X-22-164C | 90 | 2370 |

Illustrated is a single-end type reactive silicone oil (having a structure shown in Formula (2) below:

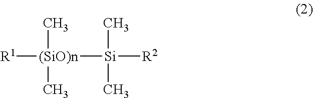

(in the above Formula (2), R¹ is a methyl group or a butyl group, and R² is a functional group represented by the Formula (1))) manufactured by Shin-Etsu Chemical Co., Ltd. shown in Table 2 below.

TABLE 2

| | | Functional group |
|---|---|---|
| | Viscosity | equivalent |
| Product name | (mm²/s) | (g/mol) |
| X-24-8201 | 25 | 2100 |
| X-22-174DX | 60 | 4600 |
| X-22-2426 | 180 | 12000 |

Illustrated is a dual-end methacrylate modified silicone oil (having a structure shown in Formula (3) below:

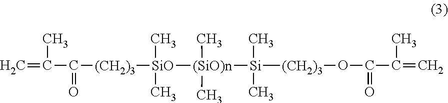

) manufactured by Dow Corning Toray Silicone Co., Ltd. shown in Table 3 below.

TABLE 3

| | | Methacryl | Specific |
|---|---|---|---|
| | Viscosity | equivalent | gravity |
| Product number | (cs/25° C.) | (g/mol) | (25° C.) |
| BX16-152B | 40 | 1300 | 0.97 |
| BY16-152 | 85 | 2800 | 0.97 |
| BX2-152C | 330 | 5100 | 0.97 |

Illustrated is a single-end methacrylate modified silicone oil (having a structure shown in Formula (4) below:

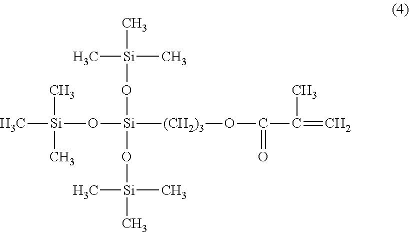

) manufactured by Dow Corning Toray Silicone Co., Ltd. shown in Table 4 below.

TABLE 4

| | | Refractive | Specific |
|---|---|---|---|
| | Viscosity | index | gravity |
| Product number | (cs/25° C.) | (25° C.) | (25° C.) |
| BX16-122A | 5 | 1.417 | 0.92 |

Illustrated are (meth)acryloxyalkylsilanes (having individual structures shown in order in Formulae (5) to (11) below:

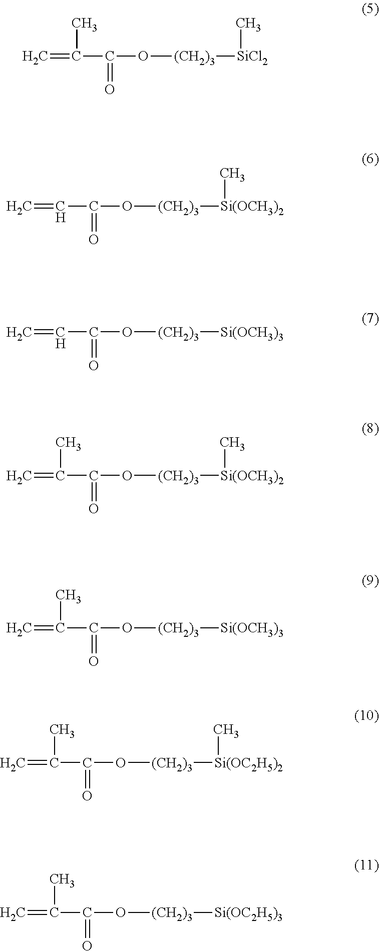

) manufactured by Shin-Etsu Chemical Industries shown in Table 5 below.

TABLE 5

| Product number | Compound name |
|---|---|
| LS-2080 | 3-methacryloxypropyldichloromethylsilane |
| LS-2826 | 3-acryloxypropyldimethoxymethylsilane |
| LS-2827 | 3-acryloxypropyltrimethoxysilane |
| LS-3375 | 3-methacryloxypropyldimethoxymethylsilane |
| LS-3380 | 3-methacryloxypropyltrimethoxysilane |
| LS-4548 | 3-methacryloxypropyldiethoxymethylsilane |
| LS-5118 | 3-methacryloxypropyltriethoxysilane |

These silicon-containing compounds may be used alone, or two or more of these may be mixed and used. Another compound not containing silicon and having a double bond between carbons may also be used in combination.

Such a silicon-containing compound having a polymerizable double bond between carbons and another compound not containing silicone and having a double bond between carbons is preferably used as monomer, oligomer or mixture of monomer and oligomer.

Another compound having a polymerizable double bond between carbon atoms which may be blended with the silicon-containing compound having a polymerizable double bond between carbon atoms is not particularly restricted, and suitably (meth)acrylate monomer or oligomer, or a mixture of monomer and oligomer. As the oligomer, dimer to icosamer are preferred.

Examples of the (meth)acrylate monomer or oligomer include urethane (meth)acrylate, epoxy (meth)acrylate, ether (meth)acrylate, ester (meth)acrylate and polycarbonate (meth)acrylate, and include fluorine (meth)acryl monomer or oligomer.

The above-mentioned (meth)acrylate oligomer can be synthesized by a reaction between a compound such as polyethylene glycol, polyoxypropylene glycol, polytetramethylene ether glycol, bisphenol A epoxy resin, phenol novolac epoxy resin, addition product of polyhydric alcohol and ∈-caprolactone, and (meth)acrylic acid, or by urethanating a polyisocyanate compound and a (meth)acrylate compound having a hydroxyl group.

Urethane (meth)acrylate oligomer can be obtained by urethanating a polyol, isocyanate compound and a (meth)acrylate compound having a hydroxyl group.

Examples of the epoxy (meth)acrylate oligomer include any reaction products of a compound having a glycidyl group, and (meth)acrylic acid. Among the products, reaction products of a compound having a ring structure(s) such as benzene ring, naphthalene ring, spiro ring, dicyclopentadiene and/or tricyclodecane and having a glycidyl group, and (meth)acrylic acid are preferred.

Further, ether (meth)acrylate oligomer, ester (meth)acrylate oligomer and polycarbonate (meth)acrylate oligomer can be obtained by reactions of corresponding polyols (polyether polyol, polyester polyol and polycarbonate polyol) and (meth)acrylic acid, respectively.

In the present invention, the ionic conductive agent is not particularly restricted as long as an expected effect of the present invention can be obtained, and examples thereof include organic ion conductive agents such as ammonium perchlorate, chlorate, hydrochloride, bromate, iodate, fluoroborate, sulfate, alkyl sulfate, carboxylate and sulfonate, for example, tetraethylammonium, tetrabutylammonium, dodecyltrimethylammonium such as lauryltrimethylammonium, hexadecyltrimethylammonium, octadecyltrimethylammonium such as stearyltrimethylammonium, benzyltrimethylammonium, modified aliphatic dimethylethylammonium.

In the present invention, since the ionic conductive agent has a low degree of dissociation of ion and is stable even under a continuous current, the agent is preferably a tertiary ammonium salt, and further, those represented by the following general formula (I):

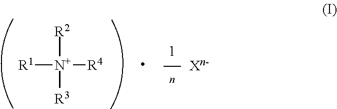

(wherein R¹ is an alkyl group having 1 to 30 carbons, an aryl group having 6 to 30 carbons or an aralkyl group having 7 to 30 carbons, R², R³ and R⁴ each independently represent an alkyl group having 1 to 6 carbons, Xⁿ⁻ represents an n-valent anion and n is an integer of 1 to 6) are more preferred.

Although the tertiary ammonium salt is hard to move due to its high molecular weight, in the present invention, by containing at least one of 1,4-butanediol acrylate and polytetramethylene glycol acrylate, the tertiary ammonium salt is dissolved, and by containing a polymer having an ethylene oxide, and making the water-absorbing quality favorable, the tertiary ammonium salt becomes easy to move. As a result, the dispersibility of the tertiary ammonium salt in the cured resin layer 102 becomes extremely favorable and a good image with uniformity and without local unevenness is obtained.

In the present invention, the polymer having an ethylene oxide is not particularly restricted as long as an expected effect of the present invention can be obtained, and examples thereof include polyethylene glycol diacrylate.

Further, in the present invention, the content of the ionic conductive agent is 0.5 to 5 parts by mass, and preferably 0.5 to 2 parts by mass with respect to the total content 100 parts by mass of an ultraviolet curable resin; at least one of 1,4-butanediol acrylate and polytetramethylene glycol acrylate; and a polymer having an ethylene oxide. When the content of the ionic conductive agent is less than 0.5 parts by mass, the ultraviolet is not fully infiltrated into a cured resin layer, thereby causing incomplete curing. On the other hand, when the content of the ionic conductive agent is more than 5 parts by mass, toner sticking occurs.

Further, in the present invention, the content of at least one of the 1,4-butanediol acrylate and polytetramethylene glycol acrylate is preferably 10 to 30 parts by mass and more preferably 20 to 30 parts by mass with respect to 100 parts by mass of an ultraviolet curable resin. When the content is less than 10 parts by mass, the water-absorbing quality may not be sufficiently obtained. On the other hand, even when the content added is more than 30 parts by mass, an effect of water-absorbing quality does not change, resulting in high cost, which is not favorable.

In the present invention, the content of the polymer having an ethylene oxide is preferably 10 to 30 parts by mass and more preferably 20 to 30 parts by mass with respect to 100 parts by mass of an ultraviolet curable resin. When the content is less than 10 parts by mass, the ionic conductive agent may not be sufficiently dissolved. On the other hand, even when the content added is more than 30 parts by mass, the effect of dissolving the ionic conductive agent does not change, resulting in high cost, which is not favorable.

In the present invention, as the method of forming the resin layer 102, a method in which a coating liquid containing the components of the above-mentioned ultraviolet curable resin, an ionic conductive agent and another additive is coated on a belt base layer 101 and cured by irradiation of ultraviolet can be suitably used. This coating liquid is preferably formed without a solvent and a solvent having high volatility at room temperature may be used as a solvent. By using such a method, a large-scale equipment and space for drying required in a method of forming the layer by drying using heat or hot air and curing can be reduced, and a variation in forming a film due to the difficulty in controlling the drying process is inhibited and the resin layer 102 can be formed with high precision.

Depending on circumstances, a method of coating the coating liquid can be appropriately selected from a dip method in which the base layer 101 which is a substrate is immersed, a spray coating method and a roll coating method, and can be used.

As a light source for irradiating ultraviolet, a mercury lamp, a high-pressure mercury lamp, an ultra-high-pressure mercury lamp, a metal halide lamp, a xenon lamp or the like can be used. Conditions for irradiating ultraviolet may be appropriately selected depending on the type of ultraviolet curable resin or the amount coated, and appropriately the luminance is about 100 to 700 mW/cm² and the accumulated quantity of light is about 200 to 3000 mJ/cm².

The thickness of the resin layer 102 is not particularly restricted, and is usually about 1 to 12 μm, particularly about 1 to 10 μm and especially about 2 to 3 μm. When the thickness is too small, a sufficient charging performance of the surface of the belt may not be secured due to abrasion in a long term use. On the other hand, when the thickness is too large, the belt surface becomes hard and damages toner, and the toner sticks to an image-forming member or the like, which may cause a problem such as a poor image.

The base layer 101 of the belt of the present invention is composed of a thermoplastic resin as a main component. As the thermoplastic resin, conventionally known materials can be appropriately selected and used. Specific examples thereof include thermoplastic polyamide (PA, nylon), thermoplastic polyarylate (PAR), thermoplastic polyacetal (POM), polyphenylenesulfide (PPS) resin, thermoplastic polyalkylene naphthalate resin such as thermoplastic polyethylene naphthalate (PEN) resin or thermoplastic polybutylene naphthalate (PBN) resin, thermoplastic polyalkylene terephthalate resin such as thermoplastic polyethylene terephthalate (PET) resin or thermoplastic polybutylene terephthalate (PBT) resin. Polymer alloy or polymer blend of two or more of these resins, polymer alloy or polymer blend of one or more of these resins and another thermoplastic resin, in particular a thermoplastic elastomer, or the like may be used. Among these, PPS, polyalkylene terephthalate, nylon or the like is preferred.

The above-mentioned thermoplastic polyamide is one of the oldest resins used as a material having a good abrasion resistance and also has an excellent strength, and is easily commercially available. There are several types of PAs, and particularly, NYLON12 (hereinafter, referred to as “PA12”), such as Trade name: Rilsan AESNO TL manufacture by Toray Industries, Inc., Trade name: DAIAMID L2101, DAIAMID L1940 manufactured by Daicel-Huels Ltd. or Trade name: 3024U manufactured by Ube Industries, Ltd. can be suitably used. PA12 has more excellent dimension stability in environmental variation compared with another PA. PA6 is also suitable. By using such a thermoplastic polyamide as a base resin of the base layer 101, an electroconductive endless belt without variation in resistance, and having an excellent strength, in particular an excellent bending durability can be obtained. The number average molecular weight of such a PA12 is suitably in a range of 7000 to 100000 and more suitably in a range of 13000 to 40000.

Examples of suitable polymer alloys of PA and thermoplastic elastomer include a block copolymer alloy of PA12 and thermoplastic polyether. By this, in addition to the dimension stability, an excellent effect of improving a low-temperature properties can be obtained. The polymer alloy of PA12 and a thermoplastic polyether is also commercially available, and representative examples thereof include Trade name: Diamide X4442 manufactured by Daicel-Huels Ltd.

As the thermoplastic elastomer which can be suitably used for a polymer blend with PA, a polymer having a Young's modulus of 98000 N/cm² or less, preferably 980 to 49000 N/cm² is known, and elastomer based on polyester, polyamide, polyether, polyolefin, polyurethane, styrene, acryl, polydiene or the like can be used. By blending such a thermoplastic elastomer, the number of folding endurance increases, thereby improving the durability against cracks. Polymer blend of PA12 and thermoplastic elastomer is also commercially available, and examples thereof include Trade name: Diamide E1947 manufactured by Daicel-Huels Ltd.

In the present invention, the blending ratios of polymer alloy and polymer blend of PA and thermoplastic elastomer are, when PA is PA12, suitably 100 parts by mass or less of thermoplastic elastomer with respect to 100 parts by mass of PA12.

Thermoplastic polyarylate has an excellent impact-resistance and dimension stability, and is an engineering plastics having good elastic recovery properties, which is easily commercially available. Representative examples thereof include U-100 manufactured by UNITIKA LTD. By employing such PAR as a base of the electroconductive endless belt, an electroconductive endless belt without variation in resistance, having an excellent strength, in particular a bending durability and creep resistance, and having a high dimensional accuracy is obtained.

Examples of suitable polymer alloy or polymer blend of PAR include polymer alloy with thermoplastic polycarbonate (PC) or thermoplastic polyethylene terephthalate (PET). Polymer alloy and polymer blend with such PAR are also commercially available. Representative examples thereof include P-3001 manufactured by UNITIKA LTD. as alloy with PC and U-8000 manufactured by UNITIKA LTD. as alloy with PET.

The thermoplastic polyacetal may be homopolymer or copolymer, and is preferably copolymer from the viewpoint of thermal stability. POM is an engineering plastics widely used for a plastic gear wheel or the like because of its balance of strength, abrasion resistance, dimension stability and moldability, and is easily commercially available. Representative examples thereof include Trade name: Tenac 2010 manufactured by Asahi Kasei Corporation and Trade name: DURACON M25-34 manufactured by Polyplastics Co., Ltd. By using such POM as the base of the electroconductive endless belt, an electroconductive endless belt without variation in resistance, having an excellent strength, in particular a bending durability and creep resistance, and having a high dimensional accuracy is obtained.

Suitable examples of polymer alloy of POM include polymer alloy with thermoplastic polyurethane, which has an excellent effect on the impact-resistance in addition to the above-mentioned properties. Polymer alloy of POM and thermoplastic polyurethane is also commercially available. Representative examples thereof include Trade name: Tenac 4012 manufactured by Asahi Kasei Corporation.

In addition, as the thermoplastic elastomer which can be suitably used for polymer blend with POM, those similar to the case of the above-mentioned PA may be exemplified. Also in this case, by the effect of blending with such thermoplastic elastomer, the number of folding endurance increases, thereby improving the durability against cracks.

The thermoplastic polyalkylene naphthalate resin is an engineering plastics having an excellent impact-resistance, dimension stability and weather resistance, and having good elastic recovery properties, and is easily commercially available. Specific examples thereof include thermoplastic polyethylene naphthalate (PEN) resin and thermoplastic polybutylene naphthalate (PBN) resin. A thermoplastic PBN resin is suitably employed.

Specific examples of the thermoplastic polyalkylene terephthalate resin include thermoplastic polyethylene terephthalate (PET) resin and thermoplastic polybutylene terephthalate (PBT) resin. Thermoplastic PET resin is suitably employed. Thermoplastic PET resin has a feature of having an excellent heat resistance, light resistance, abrasion resistance or the like.

To the base layer 101, a conducting agent is added to adjust the electroconductivity. As such a conducting agent, the ionic conductive agent or electroconductive agent mentioned in the resin layer 102 can be appropriately used, and not limited thereto. Specific examples of the electroconductive agent include electroconductive carbons such as ketjen black and acetylene black; carbons for rubber such as SAF, ISAF, HAF, FEF, GPF, SRF, FT and MT; oxidation-treated carbons for color (ink); pyrolytic carbons; natural graphite; artificial graphite; metals and metal oxides such as antimony-doped tin oxide, titanium oxide, zinc oxide, nickel, copper, silver, and germanium; electroconductive polymers such as polyaniline, polypyrrole, and polyacetylene; and electroconductive whiskers such as carbon whisker, graphite whisker, titanium carbide whisker, electroconductive potassium titanate whisker, electroconductive barium titanate whisker, electroconductive titanium oxide whisker, and electroconductive zinc oxide whisker. The amount thereof added is preferably about 0.01 to 30 parts by mass, and more preferably about 0.1 to 20 parts by mass with respect to 100 parts by mass of the base resin.

The thickness of the base layer 101 is appropriately selected depending on the form of a conveyer belt or an intermediate transfer member, and is usually preferably 85 to 150 μm.

In the base layer 101 and the resin layer 102, another functional component can be appropriately blended in addition to the aforementioned components in such a manner that the effects of the invention are not impaired. For example, various fillers, coupling agents, antioxidants, lubricants, surface treatment agents, pigments, ultraviolet absorbing agents, antistatic agents, dispersing agents, neutralizers, foaming agents and cross-linking agents may be appropriately blended. Furthermore, a coloring agent may be added to color the belt.

The surface roughness of the electroconductive endless belt of the present invention is suitably, in terms of the JIS 10-point average roughness (Rz), 10 μm or smaller, particularly 6 μm or smaller and still more preferably 3 μm or smaller. Further, as mentioned above, by adding an ionic conductive agent to the resin layer 102 and/or adding an conducting agent to the base layer 101, the volume resistivity is preferably adjusted in the range of 10² Ω·cm to 10¹³ Ω·cm.

Further, as indicated by the dashed line in FIG. 1, the electroconductive endless belt of the present invention may be equipped with a fitting part on the surface of the side contacting a driving member such as the driving roller 9 of the image forming apparatus illustrated in FIG. 2 or the driving roller 30 of FIG. 3, so that the fitting part formed on the driving member (not shown) is interlocked with the fitting part on the belt. In the electroconductive endless belt of the present invention, by providing such fitting part and allowing it to be interlocked with the fitting part (not shown) of the driving member, the electroconductive endless belt can be driven while preventing a slippage in the width direction thereof.

In this case, the shape of the aforementioned fitting parts is not particularly restricted; however, they are preferably in the form of consecutive protrusions along the circumferential direction (rotation direction) of the belt as illustrated in FIG. 1, and it is preferred that these protrusions be interlocked with recesses formed along the circumferential direction on the circumferential surface of a driving member such as driving roller.

Here, illustrated in FIG. 1(a) is an example in which one row of consecutive protrusions is provided as the fitting part; however, this fitting part may be constituted by a plurality of protrusions arranged in a line in the circumferential direction (rotation direction) of the belt. Alternatively, the fitting part may be provided in two or more rows (FIG. 1(b)) or the fitting part may be provided in the center in the width direction of the belt. Further, the fitting part may not be in the form of protrusions as shown in FIG. 1, but instead, recesses may be formed along the circumferential direction (rotation direction) of the belt, which recesses are allowed to interlock with protrusions formed along the circumferential direction on the circumferential surface of a driving member such as the aforementioned driving roller.

Examples of the image forming apparatus of the present invention using an electroconductive endless belt of the present invention include the one using a tandem method as illustrated in FIG. 2 or using an intermediate transfer method illustrated in FIG. 3, and the one using a tandem intermediate transfer method as illustrated in FIG. 4, but not limited thereto. In the case of the apparatus of FIG. 3, a voltage can be applied, from a power source 61 as appropriate, to a driving roller or a driving gear which rotates the intermediate transfer member 20. In this case, the applying conditions such as applying a direct current or applying an alternating current superposed on a direct current can be appropriately selected.

Further, in the present invention, a production method of an electroconductive endless belt includes a step of coating a coating liquid containing an ultraviolet curable resin and not containing a solvent on the base layer 101, and curing the resulting coating by irradiating ultraviolet. In such a production method, a step other than the above-mentioned step of forming resin layer 102 is not particularly restricted thereto. For example, the base layer 101 can be produced by kneading a resin composition composed of a base resin and a functional component such as a conducting agent using a biaxial kneader and subsequently extrusion-molding the thus obtained kneaded mixture with a circular die. Alternatively, a powder coating method such as electrostatic coating, a dip method or a centrifugal casting method can be suitably employed.

### EXAMPLES

The present invention will now be described in more detail by way of Examples thereof.

### Examples 1 to 9, Comparative Examples 1 to 6

Electroconductive endless belts of each of Examples and Comparative Examples were produced in accordance with the formulations shown in Tables 6 to 8. Specifically, the blend components of belt substrate listed in each of the Tables were melt-kneaded by a biaxial kneader and the thus kneaded mixture was extruded using a circular die to produce a base layer 101 having an inner diameter of 220 mm and a thickness of 100 μm and a width of 250 mm. Thereafter, a solvent coating liquid for a resin layer which was produced by using materials to be added shown in each of the Tables using methyl ethyl ketone as a solvent is coated on the base layer 101 using a spray such that the film thickness thereof after drying was 2 μm. An electroconductive endless belt 100 was obtained by, while rotating the coated belt 100, irradiating ultraviolet at a luminance of about 400 mW and an accumulated quantity of light of 1000 mJ/cm² by using UNICURE UVH-0252C apparatus manufactured by USHIO INC., and by curing the coating film of the resin layer 102.

For each of the thus obtained belts of Examples and Comparative Examples, evaluation was carried out in accordance with the procedures described below. The results thereof are collectively shown in Tables 6 to 8.

### <Number of Folding Endurance>

From each of the thus produced belts, a test piece having a length of 100 mm and width of 15 mm was cut out, and the number of folding endurance (number of folding endurance: cycles) was measured using a MIT flex fatigue resistance tester manufactured by Toyo Seiki Seisaku-Sho, Ltd. at the bending rate of 175/min, rotation angle of 135° and tensile load of 14.7 N (1.5 kgf). In the case of a base layer only, the number of folding endurance was 3000 (cycles).

### <Bleed Resistance>

Each belt was pressed on a photoconductor drum at a load of 1 kg, to be left stand still at a high temperature and at a high humidity of 40° C.×95% for one week. Thereafter, each belt was taken out and the contact portion with the photoconductor drum was visually confirmed. A stain was not observed (marked as “◯”). Some stain was observed (marked as “Δ”). Bleed occurred on the belt surface and stain on a photoconductor drum was observed (marked as “x”).

### <Evaluation of Image>

Each belt was fit on a color laser printer of an intermediate transfer method using an intermediate transfer belt shown in FIG. 3 to perform a printing test. For the printed image, an evaluation (initial image evaluation) of initial poor image was performed. A poor image is not generated (marked as “◯”). A somewhat poor image is generated (marked as “Δ”). A poor image was generated (marked as “x”). Evaluation of poor image after 5000 sheets of printing test (5K image evaluation) was performed. A poor image was not generated (marked as “◯”). A somewhat poor image was generated (marked as “Δ”). A poor image was generated (marked as “x”).

TABLE 6

| | | Example | Example | Example | Example | Example |
|---|---|---|---|---|---|---|
| | | 1 | 2 | 3 | 4 | 5 |
| resin | DPHA *¹⁾ | 80 | 70 | 60 | 60 | 60 |
| layer | 1,4-BDA *²⁾ | 10 | 10 | 10 | 10 | 10 |
| | PEG diacrylate *³⁾ | 10 | 20 | 30 | 30 | 30 |
| | tertiary ammonium salt *⁴⁾ | 2 | 2 | 2 | 5 | 0.5 |
| | metal particle *⁵⁾ | — | — | — | — | — |
| base | PPS *⁶⁾ | 100 | 100 | 100 | 100 | 100 |
| layer | carbon black *⁷⁾ | 18 | 18 | 18 | 18 | 18 |
| evaluation | number of folding | 1500 | 3000 | 3000 | 3000 | 3000 |
| | endurance (cycles) | | | | | |
| | bleed resistance | ◯ | ◯ | ◯ | Δ | ◯ |
| | initial image evaluation | ◯ | ◯ | ◯ | ◯ | ◯ |
| | 5K image evaluation | ◯ | ◯ | ◯ | ◯ | ◯ |

*¹⁾ DPHA: dipentaerythritol hexa acrylate
*²⁾ 1,4-BDA: 1,4-butanediol acrylate
*³⁾ PEG diacrylate: polyethylene glycol diacrylate
*⁴⁾ tertiary ammonium salt: lauryldimemylethylammonium ethyl sulfate anhydride (ELEGAN 26 manufactured by NOF CORPORATION)
*⁵⁾ metal particle: SN-100P manufactured by ISHIHARA SANGYO KAISHA, LTD.
*⁶⁾ PPS: Fortran W2204 manufactured by Polyplastics Co., Ltd.
*⁷⁾ carbon black: Product name: Denka Black manufactured by DENKI KAGAKU KOGYO KABUSHIKI KAISHA

TABLE 1

| | | Exam- | Exam- | Exam- | Exam- |
|---|---|---|---|---|---|
| | | ple 6 | ple 7 | ple 8 | ple 9 |
| resin | DPHA*¹⁾ | — | — | 70 | 70 |
| layer | PETEA*⁸⁾ | 70 | — | — | — |
| | urethane acrylate*⁹⁾ | — | 70 | — | — |
| | 1,4-BDA*²⁾ | — | — | 10 | 10 |
| | PTMGA*¹⁰⁾ | 10 | 10 | — | — |
| | PEG diacrylate*³⁾ | 20 | 20 | 20 | 20 |
| | tertiary ammonium | 2 | 2 | 2 | 2 |
| | salt*⁴⁾ | | | | |
| | metal particle*⁵⁾ | — | — | — | — |
| base | PPS*⁶⁾ | 100 | 100 | — | — |
| layer | PBT*¹¹⁾ | — | — | 100 | — |
| | 12-Ny*¹²⁾ | — | — | — | 100 |
| | carbon black*⁷⁾ | 18 | 18 | — | — |
| evalu- | number of folding | 3000 | 3000 | 10000 | 50000 |
| ation | endurance (cycles) | | | | |
| | bleed resistance | ◯ | ◯ | ◯ | ◯ |
| | initial image | ◯ | ◯ | ◯ | ◯ |
| | evaluation | | | | |
| | 5K image evaluation | ◯ | ◯ | ◯ | ◯ |

*⁸⁾PETEA: pentaerythritol tetraacrylate (Light Acrylate PE-4A manufactured by KYOEISHA CHEMICAL Co., LTD.)
*⁹⁾urethane acrylate: pentaerythritol triacrylate hexamethylene diisocyanate urethane prepolymer (UA-306H manufactured by KYOEISHA CHEMICAL Co., LTD.)
*¹⁰⁾PTMGA: polytetramethyleneglycol diacrylate (Light Acrylate PTMGA-250 manufactured by KYOEISHA CHEMICAL Co., LTD.)
*¹¹⁾PBT: polybutylene terephthalate (DURANEX 800FP manufactured by Polyplastics Co., Ltd.)
*¹²⁾12-Ny: polyamide12 (UBESTA Resin 3024U C01 manufactured by UBE Industries ltd.)

TABLE 8

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| resin | DPHA *¹⁾ | 100 | 90 | 60 | 60 | 60 | 60 |
| layer | 1,4-BDA *²⁾ | — | 10 | 10 | 10 | 10 | 10 |
| | PEG diacrylate *³⁾ | — | — | 30 | 30 | 30 | 30 |
| | tertiary ammonium | — | 2 | 7 | 0.1 | — | — |
| | salt *⁴⁾ | | | | | | |
| | metal particle *⁵⁾ | — | — | — | — | — | 50 |
| base | PPS *⁶⁾ | 100 | 100 | 100 | 100 | 100 | 100 |
| layer | carbon black *⁷⁾ | 18 | 18 | 18 | 18 | 18 | 18 |
| evaluation | number of folding | 1 | 1000 | 3000 | 3000 | 3000 | 1000 |
| | endurance (cycles) | | | | | | |
| | bleed resistance | ◯ | ◯ | X | ◯ | ◯ | ◯ |
| | initial image | — | ◯ | X | Δ | Δ | X |
| | evaluation | | | | | | |
| | 5K image evaluation | — | ◯ | X | X | X | X |

As shown in Table 6 and 7, in the belt of each Example, all of the number of folding endurance, bleed resistance, initial image evaluation and 5K image evaluation were favorable, and an electroconductive endless belt by which a good image with uniformity and without local unevenness could be obtained at a lower cost. On the other hand, in the Comparative Example 1, the belt broke. In the Comparative Examples 2 to 6, a sufficient number of folding endurance could not be obtained. Further, in the Comparative example 3, toner sticking occurred, and a favorable bleed resistance, initial image evaluation and 5K image evaluation could not be obtained. Still further, in Comparative Examples 4 to 6, a favorable 5K image evaluation could not be obtained.

### DESCRIPTION OF SYMBOLS

1, 11, 52a to 52d photoconductor drum
2, 7 charging roller
3 developing roller
4 developing blade
5 toner feeding roller
6 cleaning blade
8 charge-removing roller
9, 30, 55 driving roller (driving member)
10 conveyer belt
12 primary charging unit
13 image exposure unit
14, 35 cleaning unit
19 paper feeding cassette
20, 50 intermediate transfer member
25 transfer roller
26, 53 recording medium
29, 61 power source
41, 42, 43, 44 developing unit
54a to 54d first developing unit to fourth developing unit
56 secondary transfer roller
57 recording medium feeding device
58 fixing device
100 electroconductive endless belt
101 base layer
102 cured resin layer

1. An electroconductive endless belt, which is used for an image forming apparatus, in the shape of an endless belt having a laminated structure provided with at least a base layer and a cured resin layer in the mentioned order from the inside, wherein
the base layer contains a thermoplastic resin,
the cured resin layer contains an ultraviolet curable resin; an ionic conductive agent; at least one of 1,4-butanediol acrylate and a polytetramethylene glycol acrylate; and a polymer having an ethylene oxide, and
the content of the ionic conductive agent is 0.5 to 5 parts by mass with respect to the total content 100 parts by mass of an ultraviolet curable resin; at least one of 1,4-butanediol acrylate and polytetramethylene glycol acrylate; and a polymer having an ethylene oxide.

2. The electroconductive endless belt according to claim 1, wherein the ionic conductive agent is a tertiary ammonium salt.

3. The electroconductive endless belt according to claim 2, wherein the tertiary ammonium salt is represented by the following general formula (I): 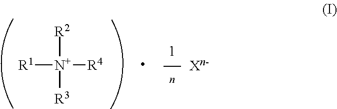
(wherein R¹ represents an alkyl group having 1 to 30 carbons, an aryl group having 6 to 30 carbons or an aralkyl group having 7 to 30 carbons; R², R³ and R⁴ each independently represent an alkyl group having 1 to 6 carbons; Xⁿ⁻ represents n-valent anion; and n is an integer of 1 to 6).

4. The electroconductive endless belt according to claim 1, wherein the content of at least one of the 1,4-butanediol acrylate and polytetramethylene glycol acrylate is 10 to 30 parts by mass with respect to 100 parts by mass of an ultraviolet curable resin.

5. The electroconductive endless belt according to claim 1, wherein the content of the polymer having an ethylene oxide is 10 to 30 parts by mass with respect to 100 parts by mass of an ultraviolet curable resin.
